(19) United States
(12) Patent Application Publication
(10) Pub. No.: US 2025/0206011 A1
(43) Pub. Date: Jun. 26, 2025

(54) METHOD FOR DETERMINING THE LOCATION-DEPENDENT STRUCTURE DEPTH OF A FLEXOGRAPHIC PRINTING PLATE OR SCANNING SURFACE

(71) Applicant: Heidelberger Druckmaschinen AG, Heidelberg (DE)

(72) Inventor: Werner Schwab, Bechtsrieth (DE)

(21) Appl. No.: 18/987,181

(22) Filed: Dec. 19, 2024

(30) Foreign Application Priority Data
Dec. 21, 2023 (DE) 10 2023 136 188.0

(51) Int. Cl. B41F 5/24; B41M 1/04

(52) U.S. Cl. CPC B41F 5/24; B41M 1/04

(57) ABSTRACT

A location-dependent structural depth of a flexographic printing plate or a scanning surface is detected. A light source irradiates a structured surface of the flexographic printing plate or scanning surface with light and a camera, which is a 1D camera or a 2D camera, detects in the light a location-dependent shaded structure generated in the path of the light. The light source and the camera are arranged relative to each other so that the camera detects the location-dependent shaded area. A computer calculates the location-dependent structure depth from the detected shaded area. This allows the structural depth of a flexographic printing plate to be determined and the result to be provided for improving the print quality. The method may be used in the manufacture of printing products in flexographic printing machines.

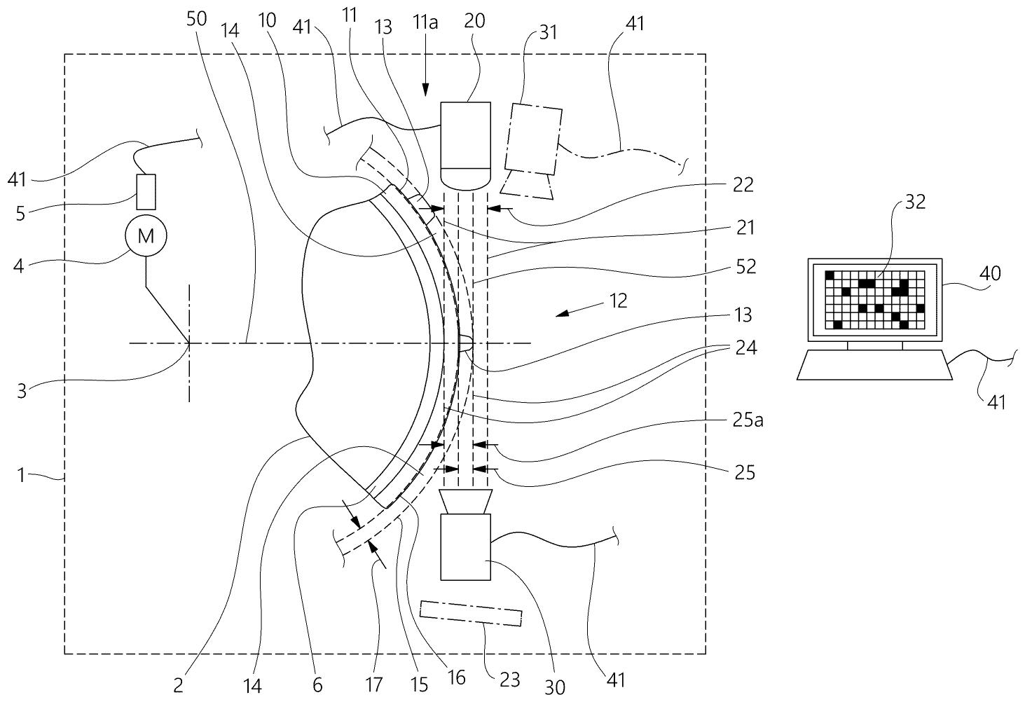

### CROSS-REFERENCE TO RELATED APPLICATION

This application claims the priority, under 35 U.S.C. § 119, of German Patent Application DE 10 2023 136 188.0, filed Dec. 21, 2023; the prior application is herewith incorporated by reference in its entirety.

### FIELD AND BACKGROUND OF THE INVENTION

The invention relates to a method for determining the location-dependent structural depth of a flexographic printing plate or scanning surface. In the method, a light source irradiates at least one portion of a structured surface of the flexographic printing plate or scanning surface with light, and a camera generates an image of the structure.

The invention lies in the technical field of the graphic design industry and in particular in the field of flexographic printing, i.e., the operation of a flexographic printing machine, i.e., a rotary printing machine for printing with flexographic printing plates; and the operation of their peripheral devices, in particular a so-called mounter, in which a plurality of flexographic printing plates are arranged on a cylinder or on a cylinder sleeve depending on the printing job. In particular, the invention relates to the sub-field of the exact measurement of “mounted” flexographic printing plates, e.g. directly in the mounter, or of scanning surfaces.

Various measurement methods are already known and in use in the graphic design industry.

European Patent EP 3465169 B1 discloses a method for determining the position of an (embossed) structure of a surface. An image acquisition system is used, which illuminates a line of the surface from different angles, detects the reflected light by means of a camera and evaluates it using a computer.

Mexican patent application MX 2010000925 A discloses an instrument for the automatic and contactless measurement of a relief and a line depth of a flexographic printing plate under industrial conditions. An interferometric sensor system is used for this purpose.

British patent application GB 2170314 A discloses a method for the contactless measurement of the depth or relief of a surface, e.g. a flexographic printing plate. This changes the focus of a focusing unit used in conjunction with a sensor unit.

European Patent EP 0 382 280 B1 discloses a method for examining and assessing flexographic clichés for irregularities in the height relief. A 3D camera is used to capture images based on triangulation methods, time-of-flight measurement or an interferometric method.

International published patent application WO 2008/049500 A2 and its counterpart U.S. Pat. No. 8,534,194 B2 disclose following rolls for measuring a printing plate.

My earlier, published patent application US 2020/0353742 A1 and its counterpart German published patent application DE 10 2020 111 341 A1 disclose a device for measuring elevations of the surface of a rotational body as outlined in the introduction above. The measurement process described there uses a reference object, for example a tensioned wire, i.e., the measurement of the elevations takes place relative to the reference object.

Flexographic printing plates used in flexographic printing are usually either etched according to a print image to be produced, i.e., usually treated locally with a solvent that locally attacks or dissolves the material of the flexographic printing plate, or directly imprinted by laser, i.e., engraved. The resulting etching depth or engraving depth is critical for the printing process and the achievable print quality. Manufacturers of flexographic printing products therefore wish to obtain information about the actual etching depth or engraving depth of a flexographic printing plate and to be able to use it to increase print quality. There is also a desire to obtain print-relevant information about scanning surfaces, e.g. surfaces of anilox rolls or scanning sleeves.

### SUMMARY OF THE INVENTION

It is therefore an object of the present invention to provide an improvement compared to the prior art, which in particular makes it possible to determine the structural depth of a flexographic printing plate or scanning surface and to provide the result for improving the print quality. It is a further object to provide for continuous quality control of the flexographic plate production process.

With the above and other objects in view there is provided, in accordance with the invention, a method for determining a location-dependent structure depth of a flexographic printing plate or scanning surface, the method comprising:
providing a light source configured to irradiate at least a portion of a structured surface of the flexographic printing plate or the scanning surface with light; and
providing a camera configured to generate an image of a structure at the portion of the structured surface or the scanning surface, the camera being a 1D camera or a 2D camera;
causing the light to strike the structure in the portion in a direction substantially parallel to the surface of the flexographic printing plate or scanning surface;
causing the structure to generate a location-dependent shaded area in a path of the light; and
wherein the light source and the camera are arranged relative to one another to enable the camera to detect the location-dependent shaded area; and
calculating by a computer the location-dependent structure depth from the location dependent shaded area detected by the camera.

In other words, there is provided a method according to the invention for determining the location-dependent structural depth of a flexographic printing plate or scanning surface, having the following steps:
providing and deploying at least one light source, which irradiates at least one portion of a structured surface of the flexographic printing plate or scanning surface with light, and providing and deploying at least one camera, which generates an image of the structure at least in the portion, is characterized in that the camera is provided as a 1D camera or as a 2D camera, that the light in the portion strikes the structure in a direction substantially parallel to the surface of the flexographic printing plate or scanning surface, that the structure generates a location-dependent shaded area in the path of the light, that the light source and the camera are arranged relative to each other in such a way that the camera detects the location-dependent shaded area, and
providing and deploying a computer which calculates the location-dependent structure depth from the detected shaded area.

The invention advantageously allows the structural depth of a flexographic printing plate or scanning surface to be determined, preferably over the entire usable length and width of the flexographic printing plate or scanning surface, and the result to be provided for improving the print quality. The invention is particularly suitable for use in the manufacture of printing products in flexographic printing machines.

The measurement process according to the invention preferably does not require a reference object different from the printing plate or scanning surface. The (radial) structure depth, on the other hand, is preferably determined relative to a base of the structure and can be determined from, for example, the width of a (radial) shaded area due to the structure or its elevations. The (radial) position of the base of the structure can also be determined, preferably in advance and in a region of the printing plate without elevations. The term “radial” in this context means: extending in the radial direction or located at a certain radial position; with reference to a midpoint of the flexographic printing plate (located on a sleeve with circular cross-section).

Knowing the structural depth of a flexographic printing plate, in particular its etching depth or engraving depth, means that the operator can draw conclusions about the etching process (dissolving by solvent, the subsequent washing and, optionally, brushing/use of a specific type of brush). For example, it is possible to gain knowledge as to how firmly the individual elevations (printing points) are anchored to the base of the printing plate (so-called base thickness). If a flexographic printing plate being measured has critical points, which are, for example, above or below a predetermined threshold for the etching depth, corrections can be made to the etching process for further printing plates. It is also possible to obtain information about the aging state of the exposure unit used and/or its intensity. An etching depth which is substantially constant over the width and length of the printing plate is preferred. Typical etching depths are, for example, in the region of 500 μm. For example, it is possible to gain knowledge as to how long the printing plate can be used without significant deficits in terms of print quality. The information from the measurement process can also be used to make appropriate adjustments to the flexographic printing plate. For example, the optimum contact pressure can be set for a flexographic printing plate with a given and measured etching depth. The print quality can be significantly improved by this measure. The same applies to printing plates that have not been etched, but have been imprinted, for example, by laser light treatment, or have been laser-engraved. In this case, the exposure intensity or exposure duration can be adjusted, for example.

The invention also offers the further advantage that the measurement of the printing plate and the information obtained about the structural depth can be used for further automation of the printing process. This may allow economies of operating personnel or absent operating personnel to be replaced.

The invention also offers the advantage that the method can be executed contactlessly and hence intrusive following rollers or other tracer elements, e.g. so-called paddles, which are not usable for fine structures, can be dispensed with for the measurement.

The method according to the invention therefore advantageously reduces production costs by automating the printing process, increases the print quality and thereby keeps production risks to a minimum.

The invention is described and shown in this application in a preferred embodiment with a dedicated light source for generating the light used for the measurement. The light source is therefore preferably a light source which is only available for this purpose. However, the term “light source” is also intended to include a light source which is already present for at least one other purpose related to the measurement of the printing plate or scanning surface, or is provided within the scope of the invention. Likewise, the term “light source” may include a light source generally present for purposes related to the measurement of the printing plate or scanning surface, such as, for example, a sufficiently strong—for the camera sensitivity—illumination of the machine or the machine environment.

In the following, preferred developments and variants of the invention (in short: developments) are described. Each of these developments and features may be combined with one another, where such combination is technically feasible.

In accordance with one development the location-dependent structure depth is a relief depth of the flexographic printing plate or scanning surface. One development can be characterized in that the relief depth is an etched relief depth. One development can be characterized in that the relief depth is a lasered relief depth. The relief depth may be defined by an envelope curve, in particular its location-dependent distance from a base of the indentations of the printing plate or scanning surface.

In accordance with a further development the relief depth is displayed as a topographic image of the flexographic printing plate or scanning surface. One development can be characterized in that the relief depth is statistically analyzed and the result of the evaluation is displayed.

In accordance with yet another development the at least one camera is a series of multiple cameras.

In accordance with another development the computer additionally calculates, i.e., determines, a thickness of the flexographic printing plate or scanning surface from the measured values. This thickness is preferably determined at the edge of the flexographic printing plate or scanning surface. One development can be characterized in that the computer additionally calculates vacant areas of the flexographic printing plate or scanning surface. Such vacant areas can be defined as regions of the printing plate in which there are no printing elevations.

In accordance with an added development of the invention, the flexographic printing plate or scanning surface is rotated and the rotation is detected by an encoder. In this way, the location-dependent structure depth can be provided with angle information (in the circumferential direction of the flexographic printing plate and/or the sleeve or scanning surface). This angle information can be used later in the flexographic printing press.

As noted, features and combinations of features disclosed above, and any features described in the following, may be combined in any technically reasonable combination within the bounds of the invention.

### SPECIFIC EXEMPLARY EMBODIMENT

Mounting a flexographic printing plate on a sleeve in a mounter for the following measurement. A flexographic printing plate or a plurality of flexographic printing plates is or are mounted (axially and/or side by side in the circumferential direction) on a sleeve. It is also preferable for a plurality of such sleeves to be processed and/or measured successively. Alternatively, etched or engraved sleeves can be measured. The mounter may be provided separately from the flexographic printing press and may also be located remotely from it. The mounter is preferably also implemented as a measuring instrument. Alternatively, the mounter and the measuring instrument can be provided separately and the sleeve can be moved from the mounter into the measuring instrument.

Optionally: identifying the sleeve by means of a unique ID assigned to the sleeve, preferably by a code, such as, for example, a barcode, QR code, RFID chip, or NFC chip.

Carrying out a contactless measurement of the diameter or radius (of the circumscribed circle, cf. FIGURE) distributed at a finite number of places and preferably over the entire width and the entire circumference of the sleeve, and calculating the relief depth according to the method according to the invention. A 1D camera or 2D camera is preferably used. Alternatively, a 3D camera or a laser triangulation method could be used.

Preferably: computational classification of the relief depth according to predetermined step heights and computational examination of whether there are regions that fall below or exceed a predetermined step height (one or more thresholds); optionally, displaying the result. The result or the values determined during this process can also be stored digitally so as to be retrievable for the flexographic printing press or the flexographic printing process. Critical regions can be notified to the operating personnel, e.g. by warning message and optionally by indicating the location of the critical region, and the operating personnel can decide whether such a printing plate is able to be printed or not; if necessary, a new printing plate is produced, in particular etched. Critical cases include, for example, printing plates with too deeply etched regions or insufficiently deeply etched regions. Both cases can result in a reduction in print quality. The decision about the usability of the printing plate can also be automated, wherein appropriate knowledge about the optimal etching depth is provided for a computational implementation of the decision, e.g. as a data collection.

Optionally: displaying the result, i.e., the relief depth as a function of the measurement location (x-y coordinates with x=width and y=circumference), preferably on a monitor.

Optionally: calculating vacant areas, i.e., regions of a specified minimum size and/or shape without printing elevations; optionally, displaying the same.

All measurement results can be transmitted directly to (the controller of) the flexographic printing press. Alternatively, the measurement results can be cached for retrieval by the flexographic printing press or for forwarding to the flexographic printing press, for example in a local digital memory or in the cloud.

Removing the sleeve(s) from the mounter (or separate measurement instrument) and pushing the respective sleeve onto an associated flexographic printing cylinder of an associated flexographic printing unit in the flexographic printing press.

For each sleeve: reading out the unique ID assigned to the sleeve and (if not already transmitted) retrieving the cached measurement results, in particular the spatially resolved relief depth.

Optionally, per sleeve: applying printing unit settings, for example, the contact pressure between the flexographic printing cylinder and the counter-pressure cylinder and/or between the scanning cylinder and the flexographic printing cylinder, or, for example, the register. Optionally, the scanning cylinder involved can also be identified beforehand by means of a unique ID.

All information important to the operating personnel, and in particular measured values, can be displayed visually, preferably on a monitor. Optionally, critical regions can be displayed directly on the flexographic printing plate, for example via a laser which illuminates the critical regions and thus visually highlights them.

Other features which are considered as characteristic for the invention are set forth in the appended claims.

Although the invention is illustrated and described herein as embodied in a method for determining the location-dependent structure depth of a flexographic printing plate or scanning surface, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawing.

### BRIEF DESCRIPTION OF THE FIGURE

The FIGURE shows a schematic illustration of a sectional view of a measuring device when carrying out a preferred exemplary embodiment of the invention and the developments.

### DETAILED DESCRIPTION OF THE INVENTION

The sole FIGURE of the drawing illustrates the sequence of the method according to the invention. A measuring device 1 is shown in operation, e.g. a so-called mounter, with a rotatable cylinder 2. The cylinder 2 can be rotated about a rotational axis 3. The rotation is driven by a motor 4. The motor 4 can be equipped with an encoder 5, in particular a rotary encoder 5; alternatively, a separate encoder may be provided. In either case, the encoder provides the necessary information regarding the instantaneous angular, or rotational, position of the cylinder 2. A sleeve 6 is received on the cylinder 2.

A flexographic printing plate 10 is received or mounted, preferably glued, on the sleeve 6. The plate has a surface 11 having a (printing) structure 11a consisting of elevations. A portion 12 of the surface 11 is optically detected or measured. In the portion 12 there is at least one printing elevation 13 (e.g. a flexographic printing surface or a flexographic printing point). Likewise, in the portion 12, there is a region with non-printing indentations 14 or vacant areas 14. The printing elevations 13 define a circumscribed circle 15. The indentations faces 14 have a base 16. The distance between this base 16 and the circumscribed circle 15 defines a depth of the structure 17, or the structure depth. The depth of the structure 11a may be given, for example, by the production process of etching/dissolving or laser machining.

The FIGURE also shows at least one light source 20, which emits light 21 with a width 22. The light 21 is received by a camera 30 which is preferably arranged opposite the light source 20. Alternatively, a reflector, in particular a mirror 23, may be provided, which reflects the light 21 back and this is then received by a camera 31 at an alternative position. The camera 31 can be positioned next to the light source 20 as shown. Alternatively, the light source 20 and the camera 31 can also form a common assembly, e.g. the light source 20 can be installed in the housing of the camera 31. It can be seen that the printing elevation 13 generates a shaded area 24 in the light 21 and that this shaded area 24 is also detected by the camera. The shaded area 24 has a width 25. The width 25 of the shaded area can be equal to the depth 17 of the structure 11a. In this respect, an image 32 can be recorded via camera 30 or 31, from which the shaded area 24 or its width 25, and in turn the depth 17 of the structure 11a, can be determined by computation. In the simplest case, the depth 17 corresponds exactly to the width 25 of the shaded area 24. A computer 40 is available via connections 41 for the necessary calculations. The light source 20 and the camera 30 or 31 and optionally the reflector or mirror 23 can be moved individually, or preferably jointly, by motorized means. In this way, it is possible to respond to different outer diameters of the sleeve 6 and/or the flexographic printing plate 10. The movement is preferably carried out perpendicular to a tangential plane to the surface to be measured. The light source 20 and the camera 30 or 31 and, if applicable, the mirror 23 can alternatively be arranged as a group rotated by 90° or 180° and carry out the measurement accordingly.

Alternatively, a scanning sleeve 6 with a scanning surface 10 can be received on the cylinder 2 and measured accordingly.

The camera 30 or 31 preferably captures such a sufficiently widely dimensioned region 21 that in the described way it is possible to detect not only the structure depth 17 of the structure 11a (of the flexographic printing plate 10 or of the scanning surface 10), but alternatively or additionally to detect the thickness of the flexographic printing plate 10 or the scanning surface 10 via its shaded area 25a. The thickness can preferably be measured at the (lateral) edge of the flexographic printing plate 10 or the scanning surface 10. With knowledge of the determined thickness of the flexographic printing plate 10 it can be checked, for example, whether the flexographic printing plate 10 has already been used (one or more times), as the thickness decreases with use.

The following is a summary list of reference numerals and the corresponding structure used in the above description of the invention:
1 measuring device, in particular mounter
2 cylinder
3 rotational axis
4 motor
5 encoder, in particular rotary encoder
6 sleeve for flexographic printing plates or scanning sleeve
10 flexographic printing plate or scanning surface
11 surface (of the flexographic printing plate or scanning surface)
11a structure
12 portion (of the surface)
13 printing elevations of the flexographic printing plate or elevations of the scanning surface
14 non-printing indentations or vacant areas, in particular etched indentations
15 circumscribed circle
16 base of the indentations
17 depth of the structure (structure depth)
20 light source(s)
21 light or capture range of the camera
22 width of the light field
23 reflector, in particular mirror
24 shaded area
25 width of the shaded area due to the printing elevation
25a width of shaded area due to flexographic printing plate or scanning surface
30 camera(s)
31 camera(s) in alternative position
32 image
40 computer
41 connections
50 radial direction
52 direction (substantially parallel to surface of flexographic printing plate)

1. A method for determining a location-dependent structure depth of a flexographic printing plate or scanning surface, the method comprising:
providing a light source and irradiating at least a portion of a structured surface of the flexographic printing plate or the scanning surface with light; and
providing a camera configured to generate an image of a structure at the portion of the structured surface or the scanning surface, the camera being a 1D camera or a 2D camera;
causing the light to strike the structure in the portion in a direction substantially parallel to the surface of the flexographic printing plate or scanning surface;
causing the structure to generate a location-dependent shaded area in a path of the light; and
wherein the light source and the camera are arranged relative to one another to enable the camera to detect the location-dependent shaded area; and
calculating by a computer the location-dependent structure depth from the location-dependent shaded area detected by the camera.

2. The method according to claim 1, wherein the location-dependent structure depth is a relief depth of the flexographic printing plate or scanning surface.

3. The method according to claim 2, wherein the relief depth is an etched relief depth.

4. The method according to claim 2, wherein the relief depth is a lasered relief depth.

5. The method according to claim 2, which comprises displaying the relief depth as a topographic image of the flexographic printing plate or scanning surface.

6. The method according to claim 2, which comprises statistically analyzing the relief depth and displaying a result of the analysis.

7. The method according to claim 1, wherein the camera is one of a series of a plurality of multiple cameras.

8. The method according to claim 1, which comprises additionally determining with the computer a thickness of the flexographic printing plate or scanning surface.

9. The method according to claim 1, which comprises additionally determining with the computer vacant areas of the flexographic printing plate or scanning surface.

10. The method according to claim 1, which comprises rotating the flexographic printing plate or scanning surface and detecting a rotation by an encoder.
